(19) United States
(12) Patent Application Publication
(10) Pub. No.: US 2005/0017185 A1
(43) Pub. Date: Jan. 27, 2005

(54) Radiation detector

(76) Inventor: Douglas Beverley Stevenson King, Preston (GB)

Correspondence Address: NIXON & VANDERHYE, PC, 1100 N GLEBE ROAD, 8TH FLOOR, ARLINGTON, VA, 22201-4714, US

(21) Appl. No.: 10/501,547

(22) PCT Filed: Jun. 29, 2004
(86) PCT No.: PCT/GB04/02805

(30) Foreign Application Priority Data
Jul. 1, 2003 (EP) 03254173.2

(51) Int. Cl. G01T 3/08

(52) U.S. Cl. 250/370.05

(57) ABSTRACT

The detection of low energy neutrons is improved using a capture material which reacts to incident particles or electromagnetic energy by emitting radiation which is more easily detected by a conventional solid state detection device.

This invention relates to a radiation detector, and primarily to the detection of low energy neutrons.

Neutrons do not carry electrical charge. When they interact with certain elements they produce secondary examples, for instance, protons or alpha particles. The neutron reaction with boron-10 produces an alpha particle, whilst the reaction with helium-3 yields a proton. Such reactions occur when neutrons are incident upon the material with very low energies, i.e. with neutrons having energy levels up to approximately 0.5 eV. Thermal neutrons tend to have energies of about 0.025 eV, i.e. well within the energy spectrum band just mentioned.

There are a number of different classes of thermal neutron detector. One class comprises boron trifluoride proportional counters. Such a counter comprises a Geiger tube filled with boron trifluoride gas enriched with boron-10. Neutron radiation is detected by detecting the resulting charged particles, i.e. the alpha particles.

Another class consists of helium-3 proportional counters. Such a counter makes use of a tube filled with helium-3 gas. In a manner similar to that described for the boron trifluoride counter, the protons resulting from incident thermal neutron radiation cause electrical conduction which is detected by an electrical circuit.

As a third class, there are so-called “bubble” detectors. Such a detector has a gel material in which are suspended very small drops of liquid. Incident neutrons transfer energy to the liquid drops, causing them to boil and become bubbles. These bubbles, trapped in the gel, are visible to the eye and are easily counted to yield a radiation dose measurement proportional to the number of bubbles formed over a given monitoring period.

It is an object of the present invention to provide an improved radiation detector.

Accordingly, the present invention provides a neutron detector comprising the combination of a solid state device including at least one sensing element having an electrical characteristic which changes in the presence of charged particles or electromagnetic radiation, and a neutron capture material which is associated with the solid state device and which has the property that it emits particles or radiation to which the sensing element or elements of the solid state device are responsive when free neutrons are incident upon it such that the solid state device provides an electrical output indicative of incident free neutrons.

Alternatively, a radiation detector for detecting radiation consisting of sub-atomic particles or electromagnetic radiation may comprise: a solid state device with at least one sensing element having an electrical characteristic which changes in the presence of incident particle or electromagnetic radiation of a first kind; and, associated with the solid state device, a capture material which has the property that incident particle or electromagnetic radiation of a second kind causes the material to emit radiation of the first kind, whereby the combination is electrically responsive to radiation of the second kind. Preferably, the capture material is incorporated in a capture layer overlying and in contact with the sensing element or elements of the solid state device. In the case of the solid state device being a CCD or APS, it has a two-dimensional array of sensing elements and the capture layer extends fully over the area of the array. In an alternative embodiment, the semiconductor material of the CCD or APS can be doped with the capture material during manufacture of the device. In this case, the elements of the device may be selectively doped in that they may be doped to differing degrees.

The use of charge coupled devices and active pixel sensor devices as radiation sensors has been disclosed in WO02/077668 for detecting proton and ion fluxes. The present invention makes use of the sensitivity of such devices to charged particle radiation to provide a detector for other kinds of radiation whilst offering the advantages of low voltage operation, low power, low mass and high reliability and sensitivity.

In terms of neutron detection, the invention provides, according to a second aspect, a detector for detecting thermal neutron radiation comprises the combination of a solid state device, for instance a semiconductor device such as a charge coupled device (CCD) or active pixel sensor (APS), which is sensitive to charged particles, and a neutron capture material which has the property that it emits charged particles in response to incident thermal neutrons.

In the case of a detector in accordance with the invention for detecting neutrons, the preferred capture materials are boron compounds containing boron-10 and helium gas containing helium-3. A capture layer may be formed of a boron-10 loaded stable solid compound such as boron-10 enriched sodium borate. Use of helium-3 as the capture material may be achieved by forming a capture layer having a solid matrix containing bubbles of the helium-3 gas.

The thickness of the capture layer may be up to 1 mm, typically 0.5 mm and thinner.

The concentration of the capture material per unit length of unit area may vary across the area of the sensing elements to yield a sensitivity variation between different parts of the array. Alternatively or in addition, a radiation filter element may be provided, overlying the capture material, the filter element being constructed as a filter layer in which the amount of radiation filtering material per unit length or unit area varies across the layer. Such variation may be achieved by arranging for the layer to have different thicknesses in registry with different parts of the sensing array.

Accordingly, by processing the electrical outputs from different parts of the array, energy spectroscopy can be performed. In the case of neutron detection, the filter material may include a radiation admitting or rejecting material such as cadmium to yield a device for performing low energy neutron spectroscopy. Such a neutron spectrometer has the advantage of low volume compared with conventional neutron spectrometers which use very large polyethylene spheres each having a gas-filled Geiger tube at the centre.

Advantageously, the detector includes a shield positioned over the sensing element or elements substantially to exclude radiation of a kind other than that to be detected.

A neutron detector in accordance with the invention may be adapted to detect incident neutrons with energies higher than 0.5 eV by applying a neutron moderator material as a filtering layer or shell over the solid state device and the capture material, the moderator shell being formed of a material which reduces the energy of neutrons passing through it. This allows the detection of high energy neutrons such as those present in cosmic radiation.

Neutron energy spectrum discrimination can also be achieved by processing the output of the solid state device according, for instance, to pulse amplitude. By counting only pulses having an amplitude greater than the predetermined threshold, the device can be made sensitive substantially exclusively to neutron radiation consisting of neutrons within a predetermined energy spectrum band. This is especially useful for alternating outputs due to high energy neutrons.

The detector can be configured as a personal dosimeter by arranging for the processor to integrate a signal or count derived from the solid state device output over a period of time, the integrated value being indicative of a received dose of radiation.

A particular detector which may be constructed in accordance with the invention is a detector sensitive to X-rays, gamma-rays, and beta-particles. In such a detector, the capture material is one which produces radiation to which the solid state device is sensitive in response to incident X-rays, gamma-rays and beta-particles. A suitable material is zinc sulphide which has the property of fluorescing or scintillating in the presence of such radiation, the emitted photons being detected by the CCD or APS.

A multi-purpose detector may be constructed by having, associated with the solid state device, a radiation capture assembly having different capture materials according to the kinds of radiation to be detected. In particular, the detector may include a plurality of different capture elements each having a different capture material or the same capture material with different concentrations, the elements being carried in a carrier member which is movable relative to the solid state device such that different capture elements may be brought into juxtaposition with the device at different times to select different detector characteristics.

Similarly, alternative filter elements may be provided on a movable carrier member to select different filter characteristics.

The same technique may be used to select different shield materials according to the radiation to be detected and radiation to be excluded.

Of course, it is possible to move the solid state device rather than a carrier member.

Applications of the invention include thermal neutron monitoring outside the biological shield of a nuclear reactor, neutron spectroscopy, personal dosimetry, thermal neutron monitoring close to aircraft fuel tanks (to detect low energy neutron radiation arising from the moderating property of hydrogen in the fuel on high energy cosmic neutrons). The invention also has particular application in the medical field. For instance, neutron radiation arising from neutron capture synovectomy can be monitored. A detector in accordance with the invention for monitoring X-rays has medical applications and applications for monitoring leakage from particle accelerators. The invention also has application in the monitoring of cosmic radiation at high altitude and in space, as well as monitoring fallout from atomic accidents and gamma radiation near nuclear reactors. X-ray spectroscopy is also possible by selection of appropriate filter materials and thicknesses.

The invention will now be described by way of example with reference to the drawings in which:

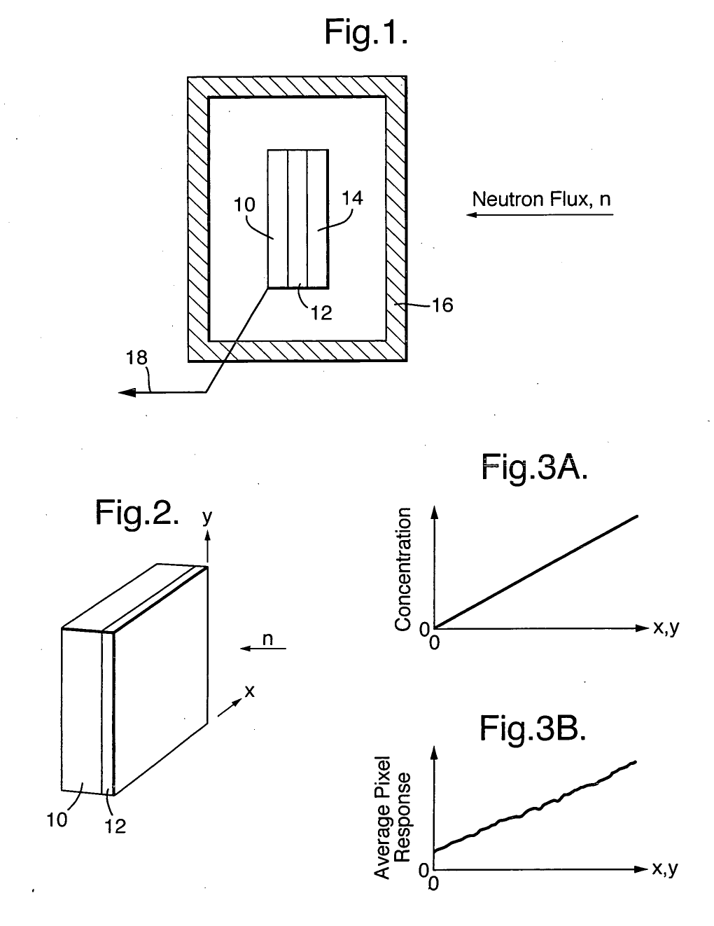

FIG. 1 is a simplified diagram of a detector in accordance with the invention;

FIG. 2 is a diagrammatic perspective view of a detector with a sensitivity profile;

FIGS. 3A and 3B are graphs showing spatial variation of capture material concentration and detector output respectively;

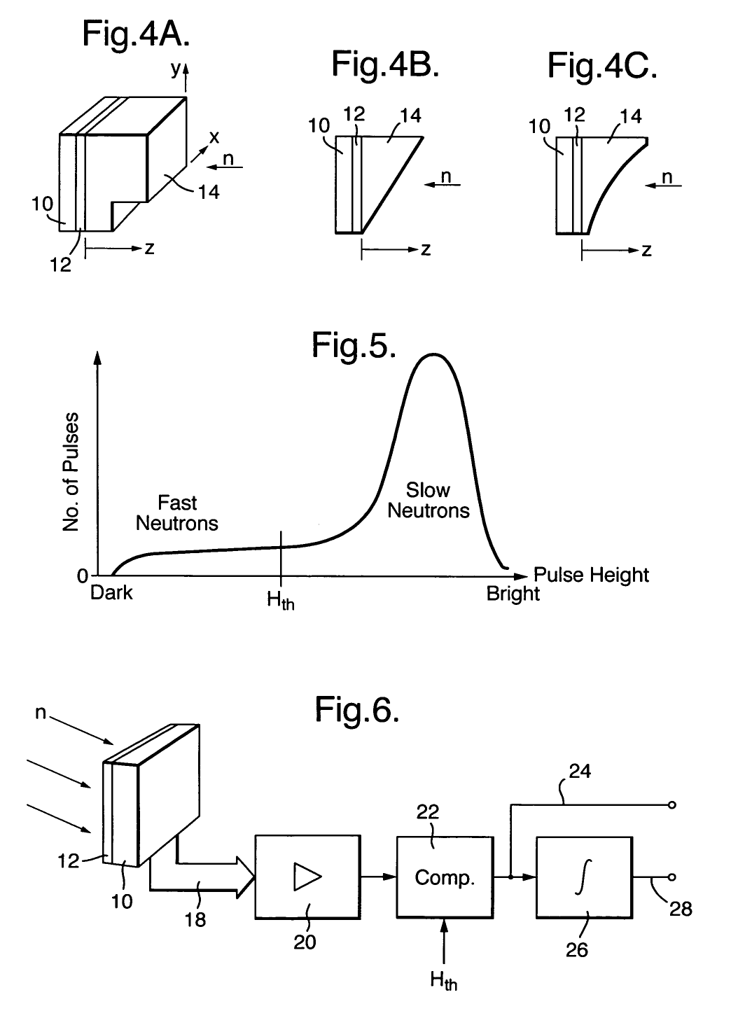

FIGS. 4A, 4B and 4C are diagrammatic views of alternative graded filter configurations, FIG. 4A being a perspective view and FIGS. 4B and 4C being side views;

FIG. 5 is a graph showing the number of pulses emitted by the detector in the presence of incident neutrons of varying energy levels;

FIG. 6 is a simplified diagram showing a detector incorporating output signal processing; and

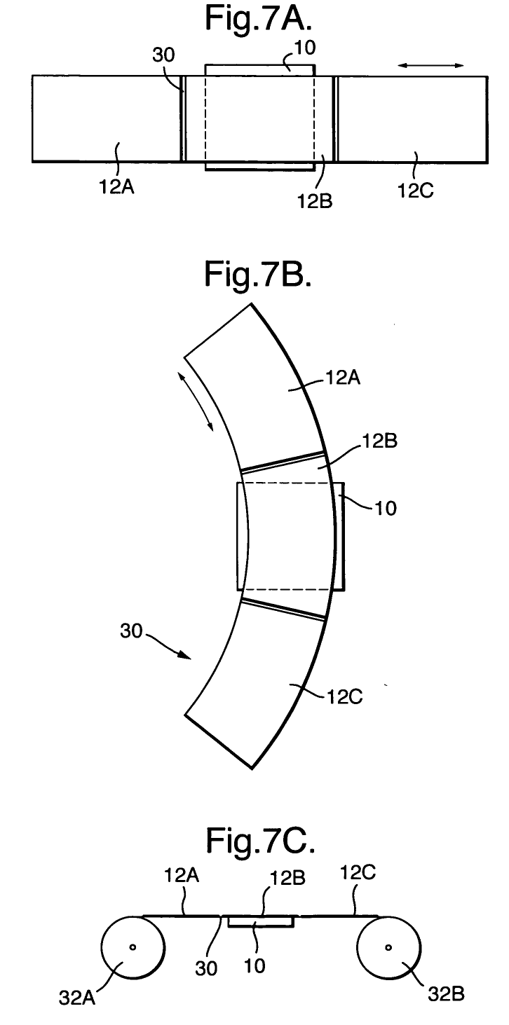

FIGS. 7A, 7B and 7C are diagrams illustrating alternative ways of selecting different radiation capture layers for a multi-purpose detector.

Referring to FIG. 1, a detector in accordance with the invention for detecting thermal neutrons N has a solid state device in the form of a CCD or APS sensor 10 with a two-dimensional array of sensing cells. Overlying the sensing cells is a radiation capture layer 12 formed from boron-10 enriched sodium borate. Other boron-10 loaded stable solid compounds may be used. Alternatively the layer 12 may comprise a gaseous layer containing helium-3 gas or a solid matrix containing bubbles of helium-3 gas.

Gas, including the helium-3 gas, may be trapped in a container which includes the sensing array in one of its walls or which encloses the sensing array so that the gas is in contact with the array. The solid matrix may comprise a mass of small gas bubbles containing the gas, the bubbles being pressed together to form a layer on the sensor array. Plastics material may be used instead of glass. In another construction, the solid matrix may be formed as a sponge-like material having sealed voids containing the gas.

The capture layer is preferably of uniform thickness and a few microns (2 to 10 microns) thick.

Placed over the combination of the capture layer and the solid state device 10, i.e. between the capture layer 12 and the expected source of neutron radiation N, is a filter layer 14 which acts as an energy discriminator.

Surrounding the assembly of the solid state device 10, the capture layer 12 and the filter layer 14 is a shield 16 formed of a high atomic mass material, for instance lead, to reduce the influence of non-neutron radiation (primarily gamma radiation). The solid state device 10, formed as an array of sensor cells, has a plurality of electrical output connections which are shown as a single output 18 in FIG. 1. Gold or tantalum should not be used owing to their propensity to become radioactive in the presence of neutron radiation. In this preferred detector, the neutron capture material in capture layer 12 is in intimate contact with the surfaces of the individual cells of the solid state device 10. Incident thermal neutrons N pass through the shield 16 and filter layer 14 to impact on the capture material in the capture layer 12. This causes secondary emission of charged particles (alpha-particles in the case of boron-10 and protons in the case of helium-3) which, owing to the proximity of the capture material to the sensor cells of the solid state device 10, produces an electrical output at the output 18 of the solid state device 10. In the case of the solid state device being a CCD or APS array, the neutron-induced emission of a single proton or alpha-particle is equivalent to tens of thousands of photons (the detection of which is the normal purpose of such devices).

Generally, the electrical output of the solid state device 10 is in the form of pulses which may be processed and counted. Accordingly, the detector as a whole can be configured to act as a solid state proportional radiation counter. Use of a CCD or APS array with a logarithmic response yields a large dynamic range.

With regard to the solid state device 10, gold bonding wires are preferably avoided since gold has the property of capturing neutrons and becoming radioactive, leading to the emission of gamma photons. For similar reasons, it is preferable to avoid use of gold eutectics for die/substrate bonding. Instead, bond wires and packaging should preferably be made of a low atomic number material (excluding boron-10 and helium-3).

The purpose of the filter layer 14 is to perform radiation filtering in the energy spectrum. By incorporating energy discriminating material such as cadmium in filter layer 14, the passage of neutron radiation to the capture layer 12 can be restricted to neutrons lying within a selected energy band.

Whilst the detector structure of FIG. 1 has been described above primarily with reference to a detector for neutron radiation monitoring, the same basic structure may be used for monitoring other kinds of radiation, by substituting alternative materials for the capture layer 12 and, insofar as they are included, for filter layer 14 and shield 16.

The concentration of the radiation capture material in the capture layer 12 may be graded across the plane of the solid state device to yield a “sensitivity profile”. Referring to FIG. 2, the capture material concentration may vary in the x-direction, or in the y-direction, or in both x- and y-directions.

The variation of concentration may be uniform or non-uniform in the x-and y-directions. Where the concentration is low, the sensitivity to incident radiation is low; where the concentration of the capture material is high, the sensitivity is high. Referring to FIGS. 3A and 3B, if the concentration of the capture material in the x- or y-direction varies as shown, then the average pixel response over a long period of time for one particular neutron energy beam varies across the sensor array correspondingly, as shown in FIG. 3B, although the waveform does not pass through the intersection of the axes (the 0-points) of FIG. 3B. As stated above, a non-linear concentration profile may be used. In particular, an alternative profile is a logarithmic one.

It is also possible to provide variable filtering across the area of the solid state device 10 by, for instance, altering the thickness of the filter layer 14, as shown in FIGS. 4A, 4B and 4C. Referring to FIG. 4A, layer 14 may be stepped, i.e. having a first thickness in the z-direction over one portion of the sensor array area and a larger thickness over another portion of the sensor array area. Alternatively, as shown in the side view of FIG. 4B, the filter layer 14 may have a wedge-shaped cross section. This produces a graded radiation energy discriminator characteristic across the area of the filter. With reference to FIG. 4C, a non-linear graded filter layer profile may be used. In each of the examples shown in FIGS. 4A, 4B and 4C, the variation in thickness occurs in the y-direction. However, the thickness may vary in the x-direction, or in both the x-direction and the y-direction.

The resulting variation in energy discrimination across the area of the sensor array permits low energy neutron spectroscopy to be performed by processing the output signals from different parts of the sensor array and performing comparisons.

Processing of the output 18 from the solid state device 10 can also be used to distinguish between neutron radiation at high energy levels and low energy levels. FIG. 5 is a graph showing how the number of pulses obtained at the output 18 of the solid state device 10 (FIG. 1) varies with pulse amplitude or height when the detector of FIG. 1, in the absence of special energy discriminating filters, is exposed to a typical neutron radiation spectrum. It will be understood that FIG. 5 is, effectively, a statistical plot obtained over a period of time. Generally, low energy neutrons (“thermal” or “slow” neutrons) yield a large amplitude, i.e. “bright” pixel responses from the sensor array, whereas high energy neutrons, i.e. “fast neutrons” (as well as gamma photons), tend to yield low amplitude pulses (i.e. “grey or dark” pixel responses). It follows, therefore, that if the output 18 from the sensor array is processed to select, for instance, for further processing only output pulses having an amplitude above a given threshold Hₜₕ, discrimination against “fast” neutrons is enhanced.

As shown diagrammatically in FIG. 6, the processor may comprise a pulse amplifier 20 the output of which feeds a comparison stage 22 in which the height of the received pulses is compared with an amplitude or height threshold Hₜₕ. The output of the comparator 22 accordingly delivers only pulses corresponding to slow neutron radiation, and is passed to an output line 24 for further processing, counting or other analysis steps.

The processor may include an integration stage 26 for integrating the selected pulse output 24 over a period of time to provide a “radiation dose” output on output line 28, as shown in FIG. 6. The integration stage 26 may, of course, be connected to integrate all received pulses rather than those selected by the comparison stage 22. It will be appreciated that the processor blocks shown in FIG. 6 may be embodied, at least in part as functions, in software.

In general, both the assembly of the solid state device 10, the capture layer 12, the filter layer 14 and the shield 16 (as shown in FIG. 1), as well as the processor described above with reference to FIG. 6, may be incorporated in a compact battery-powered package which is easily portable. Indeed, such apparatus may be embodied for general thermal neutron radiation monitoring and measurement, as a compact neutron spectrometer, or as a readily portable personal dosimeter.

We have referred above to the way in which the sensitivity of the detector described with reference to FIG. 1 can be adjusted by adjusting the concentration of the capture material in the capture layer 12. Referring to FIGS. 7A and 7B, a variable sensitivity detector can be constructed by providing a number of radiation capture layer segments 12A, 12B, 12C on a capture layer carrier member 30, the solid state device 10 and the carrier member 30 being movable relative to each other. Each radiation capture layer segments 12A, 12B, 12C has a different capture material concentration so that, as illustrated in FIG. 7A, by sliding the carrier member 30 to bring a selected capture layer segment 12A, 12B, 12C into juxtaposition with the sensor array of the solid state device 10, a required detector sensitivity can be selected.

The embodiment shown in FIG. 7A is constructed for relative sliding movement of the carrier member 30 and array 10. In an alternative embodiment, shown in FIG. 7B, the carrier member 30 and the sensor array 10 are rotatable relative to each other about an axis (not shown) spaced laterally from the array 10. In both cases, movement of the carrier member (or the array) is used to bring the required capture layer segment into overlying registry with the array 10.

In yet a further alternative embodiment, the capture layer segments may be applied to a flexible film or tape mounted on parallel bobbins 32A, 32B on opposite sides of the solid state device 10, whereby rotation of the bobbins 32A, 32B bring the required capture layer segment into registry with the device 10. The assembly of the bobbins 32A, 32B and film carrier 30, together with capture layer segments 12A, 12B, 12C, may be mounted in a removable cartridge (not shown).

The use of differing capture material segments 12A, 12B, 12C may also be used to adapt the detector to different kinds of radiation. For instance, it is known that a zinc sulphide layer fluoresces or “scintillates” on impact of X-rays, gamma rays and beta particles. The emitted light photons can be detected by a solid state device such as the CCD and APS devices mentioned above. Accordingly, one or more of the capture layer segments 12A, 12B, 12C may have a zinc sulphide layer so that the detector can be switched between neutron monitoring and X-ray or gamma-ray monitoring.

In one particular variant, the apparatus could be configured so that two adjacent capture layer segments having different capture materials could be positioned simultaneously over the sensor array, one material being located over one part of the array and the other material over the other part of the array so that one half of the array is optimised for neutron monitoring and the other half for X-ray monitoring, for instance.

Similar carrier member arrangements may be used for bringing different filter materials into registry with the solid state device 10 for selecting different filter characteristics, using, for instance, energy discriminant filter materials as described above.

Yet further, in a similar way, different shielding materials can be deployed according to the kind of radiation to be monitored.

In the case of X-ray monitoring, X-ray spectroscopy can be performed by grading filter materials across the area of the solid state device 10 or using a movable carrier member with segments of differing material concentration or thickness as described above with reference to FIGS. 7A, 7B and 7C. Additionally, X-ray detection can incorporate pulse amplitude/height discrimination, as described above, in processing the output from the solid state device 10 to select energy ranges.

A further optional feature, particularly applicable to the neutron detector arrangements described above, is a moderator shell for the detector. It is known that polyethylene and other organic materials, owing to their hydrogen content, act a neutron moderators. By interposing a shell of such material between the source of neutron radiation and the assembly of the solid state device 10, the capture layer 12 and the filter layer 14 the detector can be made sensitive to high energy neutrons. This generally means encasing the assembly in a plastics shell. Thus, the moderator material slows down high energy neutrons for capture by the assembly 10, 12, 14. In this way the use of the detector is extended to detection of cosmic radiation, the detector response lying in the energy range above 0.5 eV, and typically extends to energy levels in the region of tens of MeV. Also, although traditionally CCD and APS devices are made using silicon semiconductors, if the solid state device 10 were made using gallium arsenide the arrangement would have significantly improved radiation hardness—albeit at somewhat increase cost.

1. A neutron detector comprising the combination of a solid state device including at least one sensing element having an electrical characteristic which changes in the presence of charged particles or electromagnetic radiation, and a neutron capture material which is associated with the solid state device and which has the property that it emits particles or radiation to which the sensing element or elements of the solid state device are responsive when free neutrons are incident upon it such that the solid state device provides an electrical output indicative of incident free neutrons.

2. A detector according to claim 1, wherein the capture material is incorporated in a capture layer overlying the sensing element or elements of the solid state device.

3. A detector according to claim 2, wherein the capture material is in contact with the sensing element or elements.

4. A detector according to claim 1, wherein the solid state device has a plurality of sensing elements arranged in a distributed array.

5. A detector according to claim 4, wherein the solid state device is a charge coupled device (CCD).

6. A detector according to claim 4, wherein the solid state device is an active pixel sensor (APS).

7. A device according to claim 1, wherein the capture material is a doping material incorporated in the sensing element or elements of the solid state device.

8. A detector according to claim 4, wherein the concentration of the capture material per unit length or unit area varies across the array of sensing elements to yield a sensitivity variation between different parts of the array.

9. A detector according to claim 1, including a radiation filter element overlying the said combination, the radiation filter comprising radiation filtering material.

10. A detector according to claim 9, wherein the filter element is constructed as a filter layer in which the amount of the radiation filtering material per unit length or unit area varies across the layer.

11. A detector according to claim 1, including a shield positioned over the sensing element or elements so as substantially to exclude radiation of a kind other than the said second kind.

12. A detector according to claim 1 for detecting free neutron radiation, wherein the capture material has the property that free neutron radiation incident upon it causes it to emit charged particles and the sensing element or elements are responsive to the emitted charged particles.

13. A device according to claim 12, wherein the capture material includes boron-10.

14. A detector according to claim 13, including a capture element in the form of a layer of a boron-10 enriched borate.

15. A detector according to claim 12, wherein the capture material includes helium-3.

16. A detector according to claim 15, including a capture element in the form of a layer of a solid matrix containing bubbles of helium-3 gas.

17. A detector according to claim 12 which is sensitive to incident free neutrons with energies in the region of 0.025 eV but substantially insensitive to incident free neutrons with energies above 0.5 eV.

18. A detector according to claim 12, wherein the solid state device has a distributed array of sensing cells and, overlying the sensing cells and the capture material, a filter layer made of a neutron energy discriminating material selected to admit through the filter layer only neutrons having various energies, the thickness of the layer varying across the array of sensing cells to yield an energy spectrum sensitive profile for the detector.

19. A detector according to claim 12, including a neutron moderator layer over the solid state device and the capture material, the moderator layer being formed of a material which reduces the energy of free neutrons passing through the layer, whereby the detector is sensitive to incident free neutrons with energies higher than 0.5 eV.

20. A detector according to claim 1, including a discriminator coupled to an output of the solid state device, the discriminator selecting only electrical signals received from the output with an amplitude greater than a predetermined value.

21. A detector according to claim 1, including means for integrating an output of the solid state device over time to produce a radiation dose reading.

22. A detector according to claim 1, including a plurality of different capture elements including a capture material or materials, and a capture element carrier member carrying the capture elements, wherein the carrier member and the solid state device are positioned with respect to each other and moveable relative to each other such that different capture elements may be brought into juxtaposition with the sensing element or elements of the solid state device for the purpose of selecting different detector characteristics.

23. A detector according to claim 1, including a plurality of different filter elements and a filter carrier member carrying the filter elements, wherein the filter carrier member and the solid state device are movable relative to each other such that different filter elements may be brought into juxtaposition with the sensing element or elements of the solid device for the purpose of selecting different filter characteristics.

24. A detector according to claim 1, including a plurality of different shield members having different shielding characteristics which are selectively locatable to shield the capture material thereby substantially to exclude different kinds of unwanted radiation according to which shield member is selected.

25. A detector according to claim 1, wherein the capture material has the property that x-rays incident upon it to cause it to emit radiation to which the sensing element or elements are sensitive.

26. A detector according to claim 25, wherein the capture material has the property of emitting photons when x-rays are incident upon it.

27. A detector according to claim 26, wherein the capture material includes zinc sulphide.
